(19) United States
(12) Patent Application Publication
(10) Pub. No.: US 2025/0155020 A1
(43) Pub. Date: May 15, 2025

(54) ACTUATING DRIVE HAVING A CONTROL UNIT FOR CONTROLLING A LOCKING UNIT

(71) Applicant: OECHSLER AG, Ansbach (DE)

(72) Inventors: David Welz, Herrieden (DE); Robert Meierle, Ellingen (DE); Winfried Schmidt, Wassertruedingen (DE)

(21) Appl. No.: 18/946,087

(22) Filed: Nov. 13, 2024

(30) Foreign Application Priority Data
Nov. 14, 2023 (DE) 10 2023 131 714.8

(51) Int. Cl. F16H 63/34

(52) U.S. Cl. CPC F16H 63/3466

(57) ABSTRACT

In one aspect, an actuating drive for an electrical assembly of a motor vehicle includes a drive train, which includes a drive transmission and a drive motor for driving the drive transmission. The actuating drive also includes having a locking unit for locking the drive train, which includes a self-locking locking transmission that is operatively connected to the drive transmission, and a locking motor for driving the locking transmission. The actuating drive further includes a control unit for controlling the drive motor and the locking motor. The control unit is designed such that the drive motor and the locking motor can be operated, in particular in a starting operation, asynchronously and/or with a time delay relative to one another.

### CROSS-REFERENCE TO RELATED APPLICATIONS

The present application is based upon and claims the right of priority to German Patent Application No. 10 2023 131 714.8, filed Nov. 14, 2023, the disclosure of which is hereby incorporated by reference herein in its entirety for all purposes.

### FIELD OF THE INVENTION

The present subject matters relates to an actuating drive for an electrical assembly of a motor vehicle, in particular for a parking brake, a rear spoiler, a steering wheel, a seat, a sunroof, a window, a door, and/or a trunk lid, the actuating drive having a drive train which includes a drive transmission, in particular a non self-locking drive transmission, and a drive motor for driving the drive transmission. The actuating device also includes a locking unit for locking the drive train, with the locking unit including a self-locking locking transmission which is operatively connected to the drive transmission, and a locking motor for driving the locking transmission. The actuating drive also includes a control unit for controlling the drive motor and the locking motor.

### BACKGROUND OF THE INVENTION

DE 101 49 479 A1 describes an actuating drive for movable functional parts in motor vehicles, such as windows, doors, sunroofs, seat adjusters, electric parking brakes, or the like. The actuating drive includes a drive motor and a downstream transmission which is coupled to the movable functional part. At least one transmission part of the transmission is continuously operatively connected to an additional self-locking worm which is driven by a drive motor and a worm motor synchronously with the movement of the transmission part. The disadvantage of this actuating drive is the very low degree of efficiency.

Generally, a need exists for an actuating drive with which the disadvantages known from the prior art can be eliminated.

### SUMMARY OF THE INVENTION

In various aspects, the present subject matter is directed to an actuating drive having the features described and claimed herein. In various aspects, the disclosed actuating device is preferably compact, low-cost, low-maintenance, has a long life, and/or has a high degree of efficiency

In one aspect, the present subject matter relates to an actuating drive for an electrical assembly of a motor vehicle. The electrical assembly, for which the actuating drive can be used, can be, in particular, a parking brake, a rear spoiler, a steering wheel, a seat, a sunroof, a window, a door, and/or a trunk lid. Preferably, the actuating drive is a parking brake actuating drive, a rear spoiler actuating drive, a steering wheel actuating drive, a seat actuating drive, a sunroof actuating drive, a window actuating drive, a door actuating drive, and/or a trunk lid actuating drive. The actuating drive has a drive train. The drive train includes a drive transmission. The drive transmission is, in particular, non-self-locking. Furthermore, the drive transmission has a drive motor for driving the drive transmission.

Moreover, the actuating drive includes a locking unit for locking the drive train. This locking unit includes a self-locking locking transmission which is operatively connected to the drive transmission. Via this operative connection, the locking transmission can lock the drive transmission and the drive motor, in particular when the drive motor is not energized. In addition, the locking unit includes a locking motor for driving the locking transmission. The actuating drive also has a control unit for controlling the drive motor and the locking motor. The control unit is designed such that the drive motor and the locking motor can be operated, in particular in a starting operation, asynchronously and/or with a time delay relative to one another. Advantageously, the drive motor and the locking motor can be activated by the control unit such that a blockage in the locking transmission can be avoided and/or released. One advantage is that the locking motor can therefore be very small and low-power, which in turn reduces the overall dimensions of the actuating drive and lowers the manufacturing costs.

It is advantageous when the control unit is designed such that the drive motor and the locking motor can be operated, in particular during normal operation, synchronously and/or simultaneously.

It is advantageous when the drive transmission has at least one rotatably mounted, first transmission element. Additionally or alternatively, it is advantageous when the locking transmission has at least one rotatably mounted, second transmission element. The second transmission element is preferably operatively connected to the first transmission element of the drive transmission. The first transmission element of the drive transmission and the second transmission element of the locking transmission are preferably mounted rotatably about a common axis of rotation.

Additionally or alternatively, it is advantageous when the first transmission element has a first toothing and the second transmission element has a second toothing which differs from the first toothing.

It is advantageous when the second toothing is designed such that the second toothing, in interaction with a third transmission element, enables a self-locking of the locking transmission. This advantageous embodiment of the second toothing in combination with the third transmission element provides for an effective self-locking in the locking transmission. This leads to enhanced safety and reliability of the overall system. The advantage is improved operational reliability and thus increased user friendliness.

It is also advantageous when the locking transmission includes a third transmission element. The third transmission element preferably has a third toothing corresponding to the second toothing of the second transmission element. Due to the corresponding third toothing of the third transmission element, an efficient transmission of forces and movements in the locking transmission is made possible. This provides for optimum power and efficiency of the system. Increased efficiency and improved longevity of the system are the resulting advantages.

It is advantageous when the second and the third transmission elements are toothed, in particular directly toothed, with one another. The direct toothed engagement between the second and the third transmission elements leads to a direct and efficient transmission of force. This allows greater power and a lower energy loss. The advantages are improved energy efficiency and reduced operating costs.

It is advantageous when the locking transmission includes or is a worm drive. The worm drive has a worm and a worm gear, the worm gear preferably forming the second transmission element and/or the worm preferably forming the third transmission element. A worm drive in the locking unit offers a compact and efficient possibility for implementing the self-locking function.

In an advantageous development, the drive transmission includes a fourth transmission element. The fourth transmission element is preferably mounted rotatably about the common axis of rotation. Preferably, the fourth transmission element is mounted downstream of the first transmission element in the drive direction. Via the fourth transmission element, downstream transmission elements and/or downstream transmission stages of the drive train can be driven. Alternatively, however, the fourth transmission element can also be in the form of a transmission output.

In order to design the actuating drive to require as little installation space as possible, it is advantageous when the first transmission element is arranged between the second and the fourth transmission elements in the axial direction of the common axis of rotation.

It is also advantageous when the first, the second, and/or the fourth transmission element(s) are jointly in the form of a corotational unit. The corotational unit can be designed to exhibit play or to have no play in the circumferential direction and/or axial direction of the common axis of rotation. Accordingly, play can be formed between the first, the second, and/or the fourth transmission element(s), such that these transmission elements can rotate relative to one another in the circumferential direction of the common axis of rotation within the extent of the play. A corotational unit that can rotate within the extent of a play is, as set forth in the present subject matter, corotational. It is advantageous when the corotational unit is in the form of a multi-gear wheel, in particular a double gear wheel or a triple gear wheel. As a result, the actuating drive can be highly compact and require little installation space.

In order to reduce the structural complexity of the actuating drive, it is advantageous when the first, the second, and/or the fourth transmission elements(s) of the corotational unit, in particular the entire corotational unit, are formed in one piece, in particular in one material piece.

It is also advantageous when the corotational unit is of a multi-part design. In this case, it is advantageous when the first, the second, and/or the fourth transmission element(s) of the corotational unit are interconnected. This connection between the first, the second, and/or the fourth transmission element(s) can preferably be separable and/or inseparable. Additionally or alternatively, it is advantageous when the first, the second, and/or the fourth transmission element(s) are interlockingly, frictionally, and/or integrally interconnected.

In an advantageous development of the present subject matter, play is formed between the first and the second transmission elements, which are connected for conjoint rotation, such that the first and the second transmission elements can rotate in opposite directions in the circumferential direction of the common axis of rotation within the extent of the play. As a result, damage to the transmission elements can be avoided, in particular when the drive transmission and the locking transmission are operated asynchronously in relation to one another.

It is advantageous when the first and the second transmission elements are interconnected via a feather key connection, in particular a play-exhibiting or play-free feather key connection. As a result, a corotational connection can be formed between the first and the second transmission element(s) in a highly cost-effective and precise manner.

In an advantageous development of the present subject matter, the actuating drive includes a housing. Preferably, the corotational unit is arranged in the housing. Additionally or alternatively, it is advantageous when the corotational unit is mounted for rotation with respect to the housing. Additionally or alternatively, it is advantageous when the actuating drive includes at least one support element. The support element can be arranged in the housing and/or, in particular separably, connected thereto.

It is also advantageous when the actuating drive includes at least one bearing element, in particular an axle, a shaft, and/or a bearing pin. Preferably, the corotational unit is mounted via the at least one bearing element in at least one bearing region, in particular of the housing and/or of the support element. At the same time, the corotational unit is preferably mounted rotatably about the common axis of rotation.

Preferably, the actuating drive has an output shaft which is formed, in particular, by the fourth transmission element. Alternatively, it is advantageous when the output shaft is operatively connected, in particular directly, or indirectly via at least one fifth transmission element, to the corotational unit, in particular to the first or to the fourth transmission element.

It is advantageous when the drive motor is arranged in the housing. It is also advantageous when the drive motor is upstream of the drive transmission and/or is operatively connected to the drive transmission, in particular to the first transmission element. Via the drive motor, a drive force can be transmitted onto the output shaft via the drive transmission.

In order to be able to transmit the drive force from the drive motor onto the drive transmission, it is advantageous when the drive transmission includes a motor pinion which is non-rotatably mounted on a first motor shaft of the drive motor. Additionally or alternatively, it is advantageous when the motor pinion is operatively connected, in particular directly or indirectly operatively connected, to the first transmission element.

In an advantageous development of the invention, the motor pinion is operatively connected indirectly via at least one sixth transmission element, in particular via a gear wheel, a belt, and/or a bevel gear, to the first transmission element.

It is advantageous when the first, the second, the fourth, the fifth, and/or the sixth transmission element(s) are/is in the form of a gearwheel.

It is advantageous when the locking motor is arranged in the housing. It is also advantageous when the locking motor is upstream of the locking transmission and/or is operatively connected to the locking transmission, in particular to the second and/or the third transmission element(s).

It is advantageous when the locking motor includes a second motor shaft and/or when the third transmission element is, in particular directly, non-rotatably mounted on this second motor shaft. As a result, the actuating drive can be highly compact.

It is advantageous when only the drive motor and not the locking motor is designed to drive and actuate the actuating drive. In this context, it is advantageous when the locking motor is smaller and/or has lower electrical power than the drive motor.

In this regard, it is also advantageous when the locking motor is so small and/or has such low electrical power that, during use as intended, a blockage of the locking transmission can be released only with assistance from the drive motor. In a blockage, preferably the second transmission element, in particular the worm gear, and the third transmission element, in particular the worm, are wedged with one another.

In order to be able to design the actuating drive to require as little space as possible, it is advantageous when the first motor shaft of the drive motor is parallel to the common axis of rotation and/or is radially spaced therefrom.

Additionally or alternatively, it is advantageous when the second motor shaft of the locking motor is arranged, preferably in at least one view, obliquely, in particular perpendicularly, to the common axis of rotation and/or to the second motor shaft of the drive motor.

Furthermore, it is advantageous when the second motor shaft of the locking motor is arranged at an oblique angle to the common axis of rotation and/or to the first motor shaft of the drive motor. As a result, the actuating drive can require very little installation space.

Preferably, the control unit is an actuating drive control unit. The actuating drive control unit forms, preferably with the housing of the actuating drive, a structural unit and/or is integrated into this housing. Alternatively, it is advantageous when the control unit is an assembly control unit. The assembly control unit and the housing are structurally separated from one another. The assembly control unit can thus be a control unit of a higher-order system, for example of a parking brake and/or of a motor vehicle.

It is advantageous when the actuating drive is designed such that the drive motor and the locking motor can be activated and/or energized by the control unit separately from one another and/or independently of one another. Additionally or alternatively, it is advantageous when the drive motor and the locking motor each have a separate current supply and/or a separate voltage supply.

In an advantageous enhanced embodiment of the present subject matter, the control unit is designed such that the drive motor and the locking motor can be operated in at least one starting operation in order to avoid and/or release a blockage of the locking transmission. The blockage is formed, during use as intended, in particular between the second and the third transmission elements, in which case preferably one tooth flank of the third transmission element is wedged with a corresponding tooth flank of the second transmission element. Preferably, the control unit is designed such that it can operate the drive motor and the locking motor, in particular during a restart after a period of inactivity and/or upon a reversal of the direction of rotation of the actuating drive, in particular first, in the at least one starting operation in order to avoid and/or release a blockage of the locking transmission. Additionally or alternatively, the control unit is designed such that the drive motor and the locking motor can be operated in a normal operating mode to actuate the assembly.

It is advantageous when the control unit is designed such that the drive motor and the locking motor can be operated asynchronously, in particular in the starting operation, and/or synchronously, in particular in the normal operating mode. In a synchronous operation, mutually corresponding transmission elements of the drive transmission and of the locking transmission move synchronously in relation to one another. In an asynchronous operation, they move asynchronously in relation to one another.

According to an advantageous enhanced embodiment of the present subject matter, the control unit is designed such that, in the normal operating mode, the control unit operates the locking motor, in particular depending on the drive motor, such that a first tooth flank of the third transmission element precedes a corresponding second tooth flank of the second transmission element, in particular being spaced apart therefrom. Additionally or alternatively, it is advantageous when the control unit is designed such that, in the normal operating mode, the control unit operates the locking motor, in particular depending on the drive motor, such that a second tooth flank of the third transmission element follows a corresponding second tooth flank of the second transmission element, in particular being spaced apart therefrom. As a result, frictional losses in the locking transmission are avoided, and therefore the efficiency of the actuating drive is increased.

It is advantageous when the control unit is designed such that it can operate the actuating drive in multiple starting operations in order to avoid and/or release the blockage of the locking transmission. In this regard, it is advantageous when the control unit is designed such that, in a first starting operation, in order to avoid and/or release the blockage of the locking transmission, the control unit energizes the locking motor first and, after a first time frame, in particular additionally, energizes the drive motor. To this end, it is advantageous when the first time frame is stored in the control unit and/or is established by the control unit, in particular as a corresponding value.

Additionally or alternatively, it is advantageous when the control unit is designed such that the locking motor is energized first in the first starting operation such that the third transmission element is rotated in a direction of rotation that corresponds to a planned actuating motion of the actuating drive. Preferably, as a result, the tooth flank of the third transmission element that is located adjacent to or in contact with the corresponding tooth flank of the second transmission element moves away from the tooth flank of the second transmission element corresponding thereto. Advantageously, as a result, a collision between the second and the third transmission elements can be avoided when the drive motor is energized. In addition, a blockage between the second and the third transmission elements can be released by moving the third transmission element away from the second transmission element.

In an advantageous enhanced embodiment of the present subject matter, the control unit is designed such that the drive motor is energized in the first starting operation after the first time frame such that the second transmission element is rotated in a direction of rotation that corresponds to the planned actuating motion of the actuating drive. Preferably, as a result, the tooth flank of the second transmission element follows the corresponding tooth flank of the third transmission element, which is moving away.

It is also advantageous in this context when the first time frame is established such that, and/or determined by the control unit such that, the rotation of the second transmission element begins before the other tooth flank of the third transmission element, which is moving towards the corresponding tooth flank of the second transmission element, collides with such tooth flank of the second transmission element. As a result, a collision between the tooth flanks of the second transmission element is avoided.

According to an advantageous enhanced embodiment of the present subject matter, the control unit is designed such that, in a second starting operation, in order to avoid and/or release the blockage of the locking transmission, the control unit activates, in particular energizes, the drive motor first and, after a second time frame, in particular additionally, activates, in particular energizes, the locking motor. Preferably, a corresponding value of the second time frame is stored in the control unit and/or is determined and/or established by the control unit. Additionally or alternatively, it is advantageous when the control unit is designed such that, in the second starting operation, the control unit reverses the direction of rotation of the drive motor simultaneously with or after the activation and/or energization of the locking motor.

In this context, it is advantageous when the control unit is designed such that the drive motor is activated, in particular energized, first in the second starting operation such that the second transmission element is rotated in a direction of rotation that corresponds to or is opposite the planned actuating motion of the actuating drive. Preferably, as a result, the tooth flank of the second transmission element that is adjacent to or in contact with the corresponding tooth flank of the third transmission element moves away from the corresponding tooth flank of the third transmission element, so that preferably a blockage is released.

It is also advantageous when the control unit is designed such that the drive motor is subsequently activated, in particular energized, in the second starting operation—when the second transmission element has been rotated in a direction of rotation that is opposite the planned actuating motion of the actuating drive—such that the direction of rotation thereof reverses. As a result, the second transmission element rotates preferably in the direction of rotation corresponding to the planned actuating motion of the actuating drive.

It is advantageous when the control unit is designed such that it energizes the locking motor in the second starting operation after the second time frame such that the third transmission element is rotated in a direction of rotation that corresponds to the planned actuating motion of the actuating drive, so that the tooth flank of the third transmission element follows the corresponding tooth flank of the second transmission element, which is moving away.

It is also advantageous when the control unit is designed such that the second time frame is established such that, and/or determined by the control unit such that, the rotation of the third transmission element begins before the other tooth flank of the second transmission element, which is moving towards the corresponding tooth flank of the third transmission element, collides with such tooth flank of the third transmission element.

It is also advantageous when the control unit is designed such that it operates the drive motor and the locking motor, after each period of inactivity and/or upon every reversal of the direction of rotation of the actuating motor, first in the starting operation and/or subsequently in the normal operating mode.

It is advantageous when a current limit value of the drive motor and/or of the locking motor is stored in the control unit. Additionally or alternatively, it is advantageous when the control unit is designed such that it operates the drive motor and the locking motor in the starting operation when the at least one current limit value has been exceeded. Additionally or alternatively, it is advantageous when the control unit is designed such that it operates the drive motor and the locking motor in the starting operation after a period of inactivity and/or after a reversal of the direction of rotation of the actuating drive and/or in particular only when the at least one current limit value was exceeded, in particular immediately after the start, immediately after the reversal of the direction of rotation, and/or immediately prior to the last period of inactivity.

It is advantageous when the locking unit includes at least one sensor, in particular a rotational angle sensor and/or an end-position sensor. Preferably, the sensor is designed such that, by means thereof, in particular indirectly or directly, a relative position between the second toothing of the second transmission element and the third toothing of the third transmission element, and/or a blockage can be detected and/or determined.

In an advantageous enhanced embodiment of the present subject matter, the at least one sensor is arranged on the locking motor. Additionally or alternatively, the at least one sensor and/or the control unit are/is designed such that a position of the second and/or of the third transmission element(s), which are/is movable preferably between two end stops in a positioning range, can be determined.

It is advantageous when at least one starting operation range for the second and/or the third transmission element (s) is stored in the control unit, which starting operation range is a portion of the positioning range. Additionally or alternatively, it is advantageous when the control unit is designed such that it operates the drive motor and the locking motor in the starting operation in particular only when an actual position of the second and/or the third transmission element(s) detected via the sensor is within the stored starting operation range.

In an advantageous development of the present subject matter, the sensor is designed such that, by means thereof, a first relative position between a first tooth flank of the third transmission element and a corresponding first tooth flank of the second transmission element can be detected. Additionally or alternatively, the at least one sensor is designed such that a second relative position between a second tooth flank of the third transmission element and a corresponding second tooth flank of the second transmission element can be detected.

In another aspect, the present subject matter also relates to a method for operating an actuating drive. The actuating drive is preferably designed according to the preceding description, and the aforementioned features can be present individually or in any combination.

It is advantageous when the actuating drive and/or the method are/is designed according to the following description, and the aforementioned features can be present individually or in any combination. Preferably, the actuating drive, which is used in particular in a vehicle, has a self-locking function and/or a high degree of efficiency. After the use of the self-locking function, the actuating drive does not need to be serviced or otherwise released from the locking function, but rather is fully functional. The actuating drive includes a drive motor, in particular a large drive motor, and/or a locking motor, in particular a small locking motor. The large drive motor drives, using the motor pinion thereof, the first transmission element. The motor pinion and the first transmission element are non-self-locking. The locking motor drives the self-locking third transmission element, in particular the worm. The small locking motor using the worm thereof implements the self-locking function in the actuating drive. The locking motor and the worm are designed such that, during the operation of the drive motor, they move sufficiently rapidly together with the drive transmission and/or, provided this is permitted by the transmission play, slightly precede the drive transmission, without, for example, contributing to the drive at the transmission output, so that the locking motor and the worm do not decelerate and/or unintentionally suddenly lock up the drive transmission. The locking motor and the third transmission element, in particular the worm, are preferably not designed to additionally drive the drive transmission.

The locking motor and the third transmission element, in particular the self-locking worm, are not decoupled from the drive transmission, but rather are permanently operatively connected thereto.

Due to the toothing geometry, it is virtually impossible that the motor pinion and the third transmission element, in particular the self-locking worm, can engage into the same toothing and jointly drive the same gearwheel via the one identical toothing geometry. Due thereto, the drive motor drives, by means of the motor pinion thereof, preferably the first transmission element, and the locking motor drives, by means of the third transmission element thereof, in particular by means of the worm thereof, the second transmission element, in particular the worm gear. To this end, the first transmission element, in particular a spur gear, and the second transmission element, in particular the worm gear, are connected largely for conjoint rotation. This means that, in a one-piece embodiment of the first and the second transmission elements, the two are connected for conjoint rotation. In a multi-part embodiment of the first and the second transmission elements, a corotational connection between these components can be established with or without play.

The first and the second transmission elements can jointly be of a one-piece or multi-part design. When the first and the second transmission elements are of a multi-part design, the two can be connected without play for conjoint rotation, for example by means of a press fit or an interlocking connection. For tolerance-related reasons, it can also be advantageous, however, when the first and the second transmission elements are connected with play for conjoint rotation. This means that the play permits only a certain rotation of the second transmission element relative to the first transmission element. This can be formed, for example, by a hub of the first transmission element and a slightly larger groove on the second transmission element. The hub and the groove can also be formed on the particular other component, however. Multiple corresponding hubs and grooves can be formed on the two components.

If the actuating drive is used for applications in which a high gear reduction is required and/or there is little installation space available, such as in the use for an electric parking brake, a fourth transmission element can be connected to the first transmission element and/or to the second transmission element, in particular the worm gear, for conjoint rotation. These then jointly form a triple gear wheel. The triple gear wheel includes preferably the worm gear, a first transmission element in the form of a spur gear, and a fourth transmission element in the form of a further spur gear. These can separately or jointly be of a multi-part or one-piece design. In the triple gearwheel, the fourth transmission element drives the next transmission stage.

In an alternative embodiment, when, for example, a high gear reduction is not required, the second transmission element, in particular the worm gear, and the first transmission element can be in the form of a double gear wheel. In this case, the first transmission element drives the next transmission stage or the transmission output.

The triple gear wheel or the double gear wheel is preferably mounted via a bearing pin in and/or at the housing or other components, such as a support element and/or a support plate. The bearing pin can be non-rotatably mounted in the bearing point thereof. Alternatively, the bearing pin can be connected to the triple- or double-gear wheel for conjoint rotation. In this case, the bearing pin is rotatably mounted in the at least one bearing point thereof in the housing or a housing part.

As an alternative to the at least one bearing pin, a shaft can be used, on which the double gearwheel is non-rotatably mounted. This shaft can be the output shaft of the actuating drive. This is advantageous, in particular, with a double gear wheel, in which case a further gear reduction preferably does not subsequently take place.

It is advantageous when the first transmission element, which is an integral part of the triple- or double-gear wheel, does not need to directly follow, as a transmission stage, the drive motor and/or the motor pinion. Instead, even more transmission stages or power transmission elements, such as a belt drive, a bevel gear, etc., can be provided between the motor pinion and the first transmission element.

It can also be advantageous to position the triple- or double-gear wheel and thus the locking motor and the third transmission element, in particular the worm, closer to the transmission output. As a result, the locking unit can protect the transmission stages between the drive motor and the triple- or double-gear wheel against permanent disadvantageous loads (for example, with plastic gear wheels having creep behavior) or damage.

To ensure that the actuating drive is functional even after the use of the self-locking in the presence of a load without being serviced and does not jam the worm drive, it is advantageous when, after the use of the self-locking function in the presence of a load, the drive motor and the locking motor cannot be activated at the same time in the subsequent operation.

The blockage of the worm drive after use of the self-locking function in the presence of a load on the worm drive and upon utilization of a locking motor having low power for driving the third transmission element, in particular the worm, can pose a problem. The blockage occurs due to a wedging of the second transmission element, in particular of the worm gear, and of the third transmission element, in particular of the worm, and is released, for example, by a high occurring load on the second transmission element, a reversal of the direction of rotation of the actuating drive, or by vibrations. The wedging occurs in the engagement of the worm with the worm gear, more precisely, when the worm comes to a stop, for example, when the actuator stops, too close to one side of the tooth flank of the worm gear. If a reversal of the direction of rotation of the transmission then occurs and the drive motor and the locking motor are energized at the same time, the case arises in which, when the worm and the worm gear move in the same direction, the worm collides with a tooth flank of the worm gear and this results in the worm drive becoming wedged. The locking motor is preferably small. Accordingly, the locking motor is lower-powered than the drive motor, and therefore the locking motor cannot move the worm out of the blockage position since the tooth flank of the worm gear is also pushed by the considerably higher-powered drive of the drive motor in the direction of the worm and, as a result, the wedging is maintained. This problem can be solved when the drive motor and the locking motor can be differently activated. It is advantageous when the lower-powered locking motor and the higher-powered drive motor are activated prior to the normal operation of the actuating drive such that the blockage of the worm drive is avoided or released. This can take place using two blockage-releasing operations, specifically the first starting operation, or the preceding blockage-releasing operation, and the second starting operation, or the secure blockage-releasing operation. These blockage-releasing operations can be used individually or in combination, depending on the application. The normal operation, in which the two motors are activated at the same time, is referred to as the normal operating mode.

As described above, a blockage of the locking transmission, in particular of the worm drive, can quickly occur, for example after a change in the rotational direction of the drive transmission after a period of inactivity. In order to avoid the blockage, the locking transmission is operated after the period of inactivity in the first starting operation, or the preceding blockage-releasing operation. To this end, the small locking motor is energized first for a certain time duration and moves in the desired direction of rotation. Thereafter, the large drive motor is energized in the desired direction. Due to this method of operation, the worm slightly precedes the worm gear, i.e., if the worm were to be located too close to the tooth flank of the worm gear after the period of inactivity, the worm can still move away prior to the collision with the tooth flank of the worm gear.

When the aim is to design the actuating drive to be low-cost, additional sensor systems can be dispensed with. In this case, the control unit is unaware of the precise position of the worm between the two tooth flanks of the worm gear. The control unit is then preferably designed such that it operates the actuating drive in the first starting operation, or the blockage-releasing operation, after every period of inactivity of the actuating drive. Consequently, the locking motor is energized first for a certain time duration in the desired direction of rotation before the drive motor is also energized in the desired direction of rotation.

The case can also occur here in which the worm, during a period of inactivity, is located close to a tooth flank of the worm gear and, during operation in the first starting operation, or the blockage-release operation, impacts one of the tooth flanks of the worm gear before the worm gear is moved in the desired direction of rotation by the drive motor via the drive transmission. This does not result in a blockage of the worm drive, however, when the worm gear is driven by the higher-powered drive motor and thus does not become wedged due to impacting the worm.

The first starting operation, or the blockage-release operation, suffices for applications in which a great load is not applied at the worm gear. When a sensor system is used to detect the position of the worm, for example by using a rotational angle sensor, the control unit can be designed such that the actuating drive is usually activated in the normal operating mode and is activated in the first starting operation, or the blockage-release operation, only when the worm comes to a stop too close to a tooth flank of the worm gear during a period of activity of the actuating drive and the movement in the desired direction would result in a collision.

When neither of the two motors is driving and the locking transmission, in particular the worm drive, prevents the reverse rotation of the drive transmission and the drive motor due to the self-locking, a blockage of the worm drive frequently occurs, primarily when a high load is applied at the worm drive. In this case, the self-locking does not release the worm drive. In order to prevent this, it is advantageous to subsequently control the motors in an asynchronous and/or sequential manner.

In order to securely release the self-locking at the worm drive, it is necessary during starting or upon a reversal of the direction of rotation to release the worm, or to move the worm out of the wedging with the worm gear. To this end, the drive motor is briefly energized in the opposite direction. Furthermore, within the brief energization of the drive motor, the locking motor is energized, or started, in the opposite direction, and/or in the desired direction. Due to the rotation of the drive motor in the opposite direction, a corresponding torque is transmitted onto the first transmission element. Since the first transmission element and the second transmission element, in particular the worm gear, are connected for conjoint rotation, or are operatively connected, the torque is also applied at the second transmission element, or worm gear, and therefore the second transmission element easily moves in the opposite direction. Consequently, a load is no longer applied on the worm by the worm gear. At the same time, the locking motor drives in the desired direction, so that the worm can move and precede again. In the next step, the drive motor must be energized in the desired direction of rotation. The self-locking is then successfully released and a blockage does not occur. The actuating drive may therefore be securely moved out of the self-locking without the worm drive becoming jammed, or an existing blockage of the worm drive can be released in this way.

The control unit for the drive motor and/or the locking motor can be accommodated either in the housing of the actuating drive itself or in another control device of the vehicle.

There are actuating drives in which blockages frequently occur due to high applied loads or a very small-dimensioned locking motor. In these cases, it can make sense for the control unit to always activate the drive motor and/or the locking motor, after they have been switched off, in the first or the second starting operation, or blockage-release operation, the next time they are switched on. In this way, it is ensured that the actuating drive is always functional. In this case, additional sensors are not necessary, and therefore the actuating drive could be lower-cost. The at least one sensor could be added as necessary, however.

In actuating drives that are used as an electronic parking brake, the operation in the second starting operation, or the second blockage-releasing operation, is preferred, since, in electronic parking brakes, high loads are applied at the transmission output. Furthermore, in this application, a high degree of reliability is necessary for releasing the parking brake. In rear spoilers or window lifters, the first starting operation, or the first blockage-releasing operation, would suffice.

There are actuating drives in which a high load is applied at the worm gear and the worm only in rare cases during operation, for example, due to vibrations, temperature fluctuations, or during long periods of inactivity. In these applications, the actuating drive could usually be activated in the normal operating mode, in which case the drive motor and the locking motor are energized and/or activated in parallel and/or synchronously. In the case of a blockage, however, the actuating drive would need to be serviced and would not be functional. In order to avoid servicing, the actuating drive could be operated in one or both of the above-described starting operations, in particular as soon as a blockage is detected by the control unit.

The control unit can be designed such that, in the normal operating mode, initially both motors are activated and operated at the same time. The drive motor and the locking motor preferably each have a separate current supply and voltage supply.

It is advantageous when a current limit value of the actuating drive is established in the normal operating mode for the locking motor and/or the drive motor. The current limit value is below or can be identical to a stored maximum current value. The maximum current value acts as protection for avoiding damage to the drive transmission and/or locking transmission due to overloading. If the locking motor and/or the drive motor exceed(s) the current limit value shortly after the actuating drive is started in the normal operation mode, the blockage of the worm drive is highly likely. This is also the case when the actuating drive stops in the normal operating mode and the current limit value is exceeded shortly prior to the period of inactivity. In one or all of the above-described events, it is advantageous when the control unit operates the drive motor and the locking motor in one of the two starting operations the next time they are switched on.

Additionally or alternatively, the control unit can be designed such that, once the current limit value has been reached in the normal operating mode and the two motors have been switched off, the start-up in the first starting operation is carried out in the first step. If the blockage is not released by the first starting operation—for example, because the load on the worm gear is too great, which can be detected, for example, on the basis of the current limit value being exceeded or on the basis of a stored target value being exceeded—the start-up in the second starting operation is carried out in the second step. The established current limit values for the normal operating mode, the first starting operation, and/or the second starting operation can be identical or different from one another.

If, during the normal operation of the actuating drive, the current remains below the current limit value and if the two motors are switched off, the two motors, when switched on the next time, are activated in the normal operating mode, i.e., at the same time.

The position of the worm can be determined on the basis of sensors, such as rotational angle sensors or end-position sensors, in particular on the locking motor. There is a starting operation range, or position range, for the third transmission element, in particular the worm, which is predefined or is determined by the control unit. The starting operation range is selected such that, in this range, the blockage of the third transmission element, in particular of the worm, is highly likely. This can be empirically determined, for example, using a plurality of tests. If the control unit determines, in particular on the basis of at least one sensor, that the third transmission element, in particular the worm, is located within the starting operation range, or the established position range, the control unit selects the at least one starting operation during the next start-up and/or upon a reversal of the direction of rotation. If the third transmission element is located outside the starting operation range during these events, the actuating drive is operated in the normal operating mode.

### BRIEF DESCRIPTION OF THE FIGURES

Further advantages of the invention are described in the following exemplary embodiments, wherein:

FIG. 1 shows a schematic sectional view of an actuating drive according to a first exemplary embodiment,

FIG. 2 shows a schematic sectional view of an actuating drive according to a second exemplary embodiment,

FIGS. 3a-3c show a schematic sectional view of a second and a third transmission element of a locking transmission of an actuating drive at different points in time during a first starting operation,

FIGS. 4a-4c show a schematic sectional view of the second and the third transmission elements of the locking transmission of the actuating drive at different points in time during a second starting operation for a first direction of rotation, and

FIGS. 5a-5c show a schematic sectional view of the second and the third transmission elements of the locking transmission of the actuating drive at different points in time during the second starting operation for a second direction of rotation, which is opposite the first direction of rotation.

### DETAILED DESCRIPTION

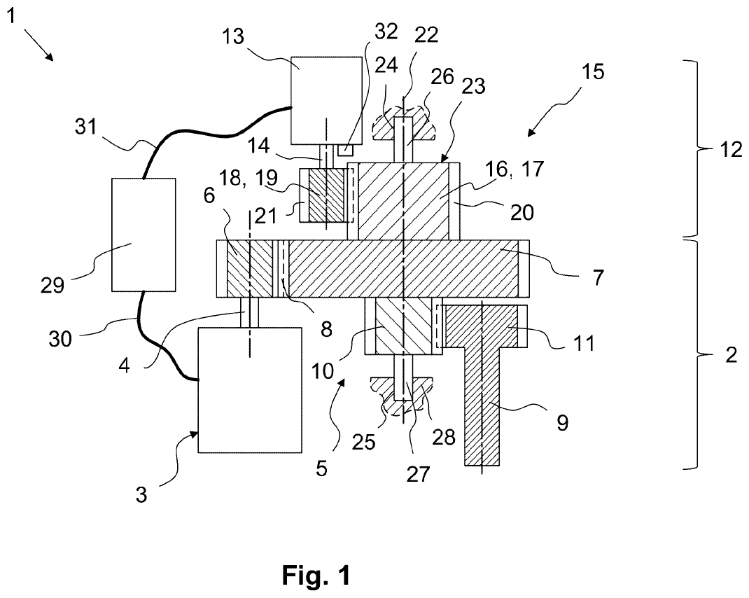

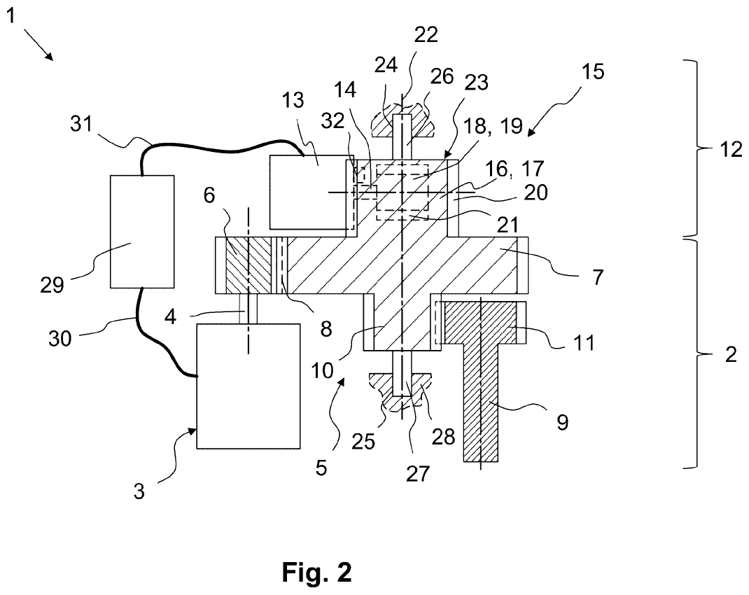

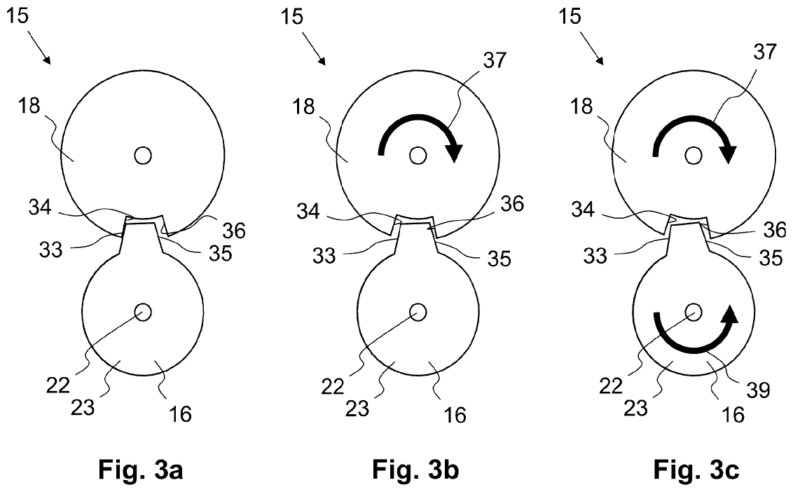

FIGS. 1 and 2 show two exemplary embodiments of an actuating drive 1 in a schematic sectional view. These actuating drives 1 are identical to one another in terms of the mode of operation thereof, which will be explained with reference to FIGS. 3a to 5c. They differ merely in terms of a few design changes, which are explained in detail in the following description. The same reference characters are used for features of the exemplary embodiment shown in FIG. 1 and for features of the exemplary embodiment shown in FIG. 2 that are identical in terms of the embodiment and/or mode of operation thereof. Unless explained otherwise in the following, the embodiment and/or mode of operation thereof correspond(s) to the embodiment and/or mode of operation of the aforementioned features.

The actuating drive 1 shown in FIG. 1 and FIG. 2 is intended for an electrical assembly of a motor vehicle. The electrical assembly (not shown here), for which the actuating drive 1 is usable, can, in particular, be a parking brake, a rear spoiler, a steering wheel, a seat, a sunroof, a window, a door, and/or a trunk lid. Preferably, the actuating drive 1 is a parking brake actuating drive, a rear spoiler actuating drive, a steering wheel actuating drive, a seat actuating drive, a sunroof actuating drive, a window actuating drive, a door actuating drive, and/or a trunk lid actuating drive.

As shown in FIG. 1, the actuating drive 1 includes a drive train 2 via which a drive force for actuating the desired assembly can be transmitted. The drive train 2 has a drive motor 3. The drive motor 3 is preferably an electric motor that can be energized. The drive motor 3 has a first motor shaft 4.

In addition, the drive train 2 has a drive transmission 5. The drive transmission is non-self-locking. Consequently, when a force is applied at the transmission output of the drive transmission 5, the drive transmission can be moved, in particular rotated in reverse, when the drive motor 3 is switched off and/or non-energized.

The drive transmission 5 includes a motor pinion 6, which is connected to the first motor shaft 4 for conjoint rotation. In addition, the drive transmission 5 has a rotatably mounted, first transmission element 7. The first transmission element is preferably a gear wheel, in particular a spur gear. According to the exemplary embodiment shown in FIG. 1, the first transmission element 7 engages into the motor pinion 6. Consequently, the first transmission element 7 is directly mechanically operatively connected to the motor pinion 6. The first transmission element 7 has a first toothing 8. When the motor pinion 6, as in the exemplary embodiment shown in FIG. 1, is directly mechanically operatively connected to the first transmission element 7, the motor pinion 6 has a toothing corresponding to the first toothing 8 of the first transmission element 7. Alternatively, it is also possible, however, that, in an exemplary embodiment not shown here, at least one sixth transmission element is arranged between the motor pinion 6 and the first transmission element 7. The sixth transmission element can be a gearwheel, a belt, and/or a bevel gear. Consequently, in this alternative exemplary embodiment, the motor pinion 6 would be indirectly mechanically operatively connected to the first transmission element 7 via the at least one sixth transmission element.

The drive train 2 has, as shown in FIG. 1, an output shaft 9. The output shaft 9 can form the transmission output of the actuating drive 1. It is also possible, however, that adjoined to the output shaft 9 is at least one further transmission element and/or one further transmission stage which converts, for example, the rotational movement of the output shaft 9 into a translatory movement. Additionally or alternatively, at least one planetary stage can also adjoin to the output shaft 9.

As is suggested by FIG. 1, the drive train 2 according to the exemplary embodiment shown includes a fourth transmission element 10. The fourth transmission element is downstream of the first transmission element 7 in the output direction of the drive train 2. This fourth transmission element 10 can also preferably be a gear wheel, in particular a spur gear. Downstream of the fourth transmission element 10, as shown in FIG. 1, there is at least one fifth transmission element 11. The fourth transmission element 10 and the fifth transmission element 11 are directly mechanically operatively connected and/or mesh with one another. The fifth transmission element 11 is connected to the output shaft 9 for conjoint rotation. The fifth transmission element 11 and the output shaft 9 can be formed in one piece.

In an alternative exemplary embodiment that is not shown here, the actuating drive 1 can also be designed such that the fourth transmission element 10 forms the output shaft 9 and/or is designed as the output shaft. In this case, the fourth transmission element 10 does not need to have a toothing.

According to the present exemplary embodiment, a drive force generated by the drive motor 3 is therefore transmitted onto the first transmission element 7 via the motor pinion 6. The fourth transmission element 10 is connected to the first transmission element 7 for conjoint rotation. The fourth transmission element 10 and the first transmission element 7 can be separate parts that are connected for conjoint rotation. Alternatively, these can also be interconnected by means of a one-piece design. Consequently, the fourth transmission element 10 rotates together with the first transmission element 7. The fourth transmission element 10 meshes with the fifth transmission element 11 and, as a result, transmits the drive force onto the output shaft 9. The output shaft is, according to the figure, preferably connected to the fifth transmission element 11 for conjoint rotation.

If a force causing rotation in reverse is then applied at the output shaft 9 (for example, in the case of an activated parking brake), the drive transmission 5 and the drive motor 3 will rotate in reverse as soon as an opposing force is not applied by the drive motor 3. This is due to the fact that the drive transmission 5 is non-self-locking. Although one advantage of the non-self-locking drive transmission 5 is a high degree of efficiency, a self-locking of the actuating drive 1 is indispensable for many applications.

For this reason, the actuating drive 1 according to the exemplary embodiment shown in FIG. 1 includes a locking unit 12. The locking unit 12 has a locking motor 13. The locking motor 13 is preferably an electric motor and/or includes a second motor shaft 14. Moreover, the locking unit 12 has a locking transmission 15. The locking transmission 15 is downstream of the locking motor 13. The locking transmission has at least one rotatably mounted, second transmission element 16. The locking transmission 15 also has a rotatably mounted, third transmission element 18. The second transmission element 16 and the third transmission element 18 are mechanically operatively connected, in particular directly as shown in FIG. 1 (i.e., without the intermediate connection of another transmission element). Accordingly, these engage, preferably directly, into one another and/or are toothed with one another.

The second transmission element 16 has a second toothing 20. In comparison to the first toothing 8 of the first transmission element 7, the second toothing 20 of the second transmission element 16 is differently designed. Accordingly, the first toothing 8 of the first transmission element 7 is preferably designed such that it is not self-locking in interaction with another transmission element, in the present case in particular with the motor pinion 6. The first toothing 8 of the first transmission element 7 can be, for example, a helical toothing. In contrast thereto, the second toothing 20 of the second transmission element 16 is designed such that it is self-locking in interaction with another transmission element, in the present case in particular with the third transmission element 18. To this end, the second toothing 20 is, for example, a worm gear toothing. The third transmission element 18, in particular the worm 19, has a third toothing 21. This third toothing 21 corresponds with the second toothing 20 of the second transmission element 16 such that these, in interaction, form a self-locking of the locking transmission 15.

In order to provide the locking transmission 15 with a correspondingly self-locking effect, it is advantageous when the locking transmission 15 in particular includes a worm drive or is in the form of a worm drive. Here, the worm drive has a, preferably input-side, worm 19 and an, in particular output-side, worm gear 17. In the exemplary embodiment shown in FIG. 1, the second transmission element 16 is in the form of a worm gear 17. Moreover, the third transmission element 18 is in the form of a worm 19. Alternatively, however, this could also be oppositely designed. Consequently, the second transmission element 16 and the third transmission element 18 have mutually corresponding toothings—specifically the second toothing 20 and the third toothing 21—which, in interaction, bring about a self-locking of the locking transmission 15. The worm gear 17 directly engages, in particular with the second toothing 20 thereof, into the worm 19, in particular into the third toothing 21. As shown in FIG. 1, the third transmission element 18, in particular the worm 19, is non-rotatably mounted on the second motor shaft 14 of the locking motor 13.

In order to enable the locking unit 12 to lock the drive train 2, the locking transmission 15 is mechanically operatively connected to the drive transmission 5, in particular via a (preferably corotational) interface. This interface is formed between the first transmission element 7 of the drive transmission 5 and the second transmission element 16 of the locking transmission 15. To this end, the first transmission element 7 and the second transmission element 16 are located on a common axis of rotation 22. Both the first transmission element 7 and the second transmission element 16 are mounted in particular jointly rotatably about this common axis of rotation 22. In order to ensure, in particular when the drive motor 3 is switched off, that the self-locking effect, or the locking force of the locking transmission 15, can be transmitted onto the drive transmission 5, the second transmission element 16 is connected and/or coupled to the first transmission element 7 for conjoint rotation. The first transmission element 7 of the drive transmission 5 and the second transmission element 16 of the locking transmission 15 therefore form a corotational unit 23 that is mounted rotatably about the common axis of rotation 22.

According to the first exemplary embodiment shown in FIG. 1, the first transmission element 7 and the second transmission element 16 are separate parts, in particular gear wheels, which are, in particular separably and/or inseparably, interconnected, so that these rotate jointly as a corotational unit 23. The first transmission element 7 and the second transmission element 16 can be interlockingly, frictionally, and/or integrally interconnected for this purpose. The integral parts of the corotational unit 23 can be interconnected without play or with play in the circumferential direction of the common axis of rotation 22. Accordingly, play can be formed, for example, between the first transmission element 7 and the second transmission element 16 connected thereto for conjoint rotation, so that these can rotate relative to one another in the circumferential direction of the common axis of rotation 22 within the extent of the play. A relative rotatability within the extent of play is therefore also to be understood as a corotational connection. As a result, damage to the first transmission element 7 and/or the second transmission element 16 during an asynchronous and/or time-delayed activation of the drive motor 3 and the locking motor 13 can be avoided when corresponding tooth flanks of the first transmission element 7 and of the second transmission element 16 impact one another. Moreover, by using correspondingly designed play, a blockage between the second transmission element 16 and the third transmission element 18 can be released using less force.

When, during use as intended, with the drive motor 3 deactivated, a reverse-rotation force is then applied at the output shaft 9 that attempts to rotate the drive transmission 5 and the first motor shaft 4 in reverse, this reverse-rotation force also acts on the locking transmission 15 due to the corotational connection between the first transmission element 7 and the second transmission element 16. Since the locking transmission 15 is self-locking due to the toothing between the second transmission element 16 and the third transmission element 18, the reverse-rotation force is counteracted by a locking force that is transmitted onto the first transmission element 7 via the interface, or corotational connection, between the first transmission element 7 and the second transmission element 16. As a result, the drive transmission 5 is prevented from rotating in reverse.

As shown in FIG. 1, the fourth transmission element 10, similar to the first transmission element 7 and the second transmission element 16, is rotatably mounted on the common axis of rotation 22. Consequently, the first transmission element 7, the second transmission element 16, and/or the fourth transmission element 10 are arranged concentrically, in particular with the common axis of rotation 22. The first transmission element 7 is arranged between the second transmission element 16 and the fourth transmission element 10 in the axial direction of the common axis of rotation 22. The fourth transmission element 10 is, according to the exemplary embodiment shown in FIG. 1, a separate part and is, in particular separably or inseparably, connected to the first transmission element 7 for conjoint rotation. The connection between the first transmission element 7 and the fourth transmission element 10 can be an interlocking, frictional, and/or integral connection. Furthermore, play can be formed between the first transmission element 7 and the fourth transmission element 10 in the circumferential direction of the common axis of rotation 22, so that these can rotate in the circumferential direction within the extent of this play. According to the exemplary embodiment shown in FIG. 1, the fourth transmission element 10 is therefore an integral part of the corotational unit 23. In an exemplary embodiment that is not shown here, it is also conceivable, however, that the first transmission element 7 and the fourth transmission element 10 are formed in one piece. Alternatively, however, the first transmission element 7 and the second transmission element 16 can also be formed in one piece.

A corotational connection between the first transmission element 7 and the second transmission element 16 and/or a corotational connection between the first transmission element 7 and the fourth transmission element 10 can be formed, in particular, via a feather key connection, preferably a play-exhibiting or play-free feather key connection. The feather key connection can be formed directly between the aforementioned components but also indirectly via another component, such as a shaft.

As is suggested by FIG. 1, the corotational unit 23 is accommodated in a first bearing region 24 and/or a second bearing region 25 and/or is rotatably mounted therein, so that the corotational unit can rotate about the common axis of rotation 22. The actuating drive 1 includes a housing 28. The first bearing region 24 and/or the second bearing region 25 are/is formed in the housing 28. Additionally or alternatively, the actuating drive 1 can have a support element (not shown here), in particular a support plate, which is arranged in the housing 28. At least one of the bearing regions 24, 25 can also be formed on or in the support element. Furthermore, individual components of the drive train 2 and/or of the locking unit 12 can be arranged on the support element and/or mounted therein.

According to the exemplary embodiment shown in FIG. 1, the corotational unit 23 is, in particular rotatably, mounted in at least one of the bearing regions 24, 25 via at least one bearing element 26, 27. The at least one bearing element 26, 27 can also be connected to the corotational unit 23 for conjoint rotation. In addition, the at least one bearing element 26, 27 can be formed as one piece with the corotational unit 23. In the present case, the bearing elements 26, 27 are in the form of bearing pins that are rotatably accommodated in appropriately corresponding bearing regions 24, 25 of the housing 28.

The locking motor 13 is smaller than the drive motor 3. Additionally or alternatively, the locking motor 13 can have lower electrical power. As a result, the actuating drive 1 can be highly compact and require little installation space. During use as intended, a blockage can occur in the locking transmission 15. In the process, the tooth flanks 33, 35 of the second transmission element 16, in particular of the worm gear 17, become wedged with corresponding tooth flanks 34, 36 of the third transmission element 18, in particular the worm 19. The locking motor 13 can be so small and/or have such low electrical power that, during use as intended, the locking motor cannot release the blockage of the locking transmission 15 alone but rather only with assistance from the drive motor 3.

As is suggested by the exemplary embodiment shown in FIG. 1, the first motor shaft 4 of the drive motor 3 is oriented parallel to the common axis of rotation 22. Moreover, the second motor shaft 14 of the locking motor 13 is oriented parallel to the common axis of rotation 22.

In order to be able to control the drive motor 3 and the locking motor 13, the actuating drive 1 includes a control unit 29. The drive motor 3, the drive transmission 5, the locking motor 13, the locking transmission 15, and/or the control unit 29 can be arranged, in entirety or in part, in the housing 28 and/or integrated therein. Alternatively, the control unit 29 can also be a component that is separate from the housing 28 and/or designed to be spatially separated therefrom. The control unit 29 is electrically connected to the drive motor 3 via a first electrical line 30. Moreover, the locking motor 13 is electrically connected to the control unit 29 via a second electrical line 31. The first electrical line 30 and the second electrical line 31 are separated from each other. The drive motor 3 and the locking motor 13 can be activated by the control unit 29 separately and/or independently of one another, in particular asynchronously and/or with a time delay relative to one another.

As shown in FIG. 1, the locking unit 12 includes at least one sensor 32. The sensor 32 is arranged in the region at and/or in the locking motor 13. The sensor 32 is preferably a rotational angle sensor and/or an end-position sensor. The sensor 32 and/or the control unit 29 are/is designed such that, by means of the sensor 32, a relative position between the second toothing 20 of the second transmission element 16 and the third toothing 21 of the third transmission element 18 can be indirectly or directly determined. Additionally or alternatively, the sensor 32 and/or the control unit 29 are/is designed such that a blockage of the locking transmission 15 can be detected. The blockage can occur during use as intended, in particular between the second transmission element 16 and the third transmission element 18, in particular when a tooth flank of the second toothing 20 is wedged together with a tooth flank of the third toothing 21.

According to one exemplary embodiment, by means of the control unit 29 and/or the at least one sensor 32, a position of the second transmission element 16 and/or of the third transmission element 18 within an, in particular maximum, positioning range (within which the transmission element 16, 18 can be moved) can be determined. Accordingly, the second transmission element 16 and/or the third transmission element 18 can be moved between two end stops, each of which forms an end point of the positioning range. A position within this positioning range can be determined via the sensor 32. Moreover, at least one starting operation range can be stored for the second transmission element 16 and/or for the third transmission element 18. The at least one starting operation range forms a portion of the positioning range. The starting operation range is selected such that the likelihood of a blockage is greatly increased when the second transmission element 16 and/or the third transmission element 18 are/is stopped within this starting operation range and/or a reversal of the direction of rotation of the actuating drive 1 takes place at this position. When the presently described event occurs, the control unit 29 can be designed such that it activates the drive motor 3 and/or the locking motor 13 such that a blockage is avoided and/or an existing blockage is released. The operations and/or control programs that are suitable for this purpose are explained in detail in the following description.

The actuating drive 1 can also be designed, however, such that the actuating drive can detect a blockage without using the at least one sensor 32. In order to be able to detect, even without the sensor 32, a blockage of the locking transmission 15 and/or a position of the locking transmission 15, in which a blockage is very highly likely present or possible, a current limit value of the drive motor 3 and/or of the locking motor 13 can be stored in the control unit 29. The control unit 29 detects that a blockage is very likely present when the current limit value was exceeded immediately after the start, immediately after the reversal of the direction of rotation, and/or immediately prior to the last period of inactivity.

As mentioned above, FIG. 2 shows a schematic representation of a second exemplary embodiment of the actuating drive 1. In the following description of the alternative exemplary embodiment shown in FIG. 2, identical reference characters are used for features that are identical in terms of the embodiment and/or mode of operation thereof in comparison to the first exemplary embodiment shown in FIG. 1. Unless explained otherwise in the following, the embodiment and/or mode of operation thereof correspond(s) to the embodiment and/or mode of operation of the aforementioned features.

The second exemplary embodiment shown in FIG. 2 differs from the first exemplary embodiment shown in FIG. 1 substantially by the arrangement of the locking motor 13 and/or of the third transmission element 18, in particular of the worm 19, relative to the corotational unit 23. Accordingly, the second motor shaft 14 and/or an axis of rotation of the third transmission element 18 are/is arranged obliquely, in particular perpendicularly, to the common axis of rotation 22 of the corotational unit 23. Furthermore, the third transmission element 18 is located, according to the figure, underneath the second transmission element 16.

A further difference is in the embodiment of the corotational unit 23. Accordingly, the corotational unit 23 in the exemplary embodiment shown in FIG. 2 is formed in one piece, in particular in one material piece. Consequently, there is no play between the first transmission element 7 and the second transmission element 16. The same applies for the one-material-piece connection between the first transmission element 7 and the fourth transmission element 10. The corotational unit 23 can also be formed in one piece, in particular in one material piece, in the exemplary embodiment of the actuating drive 1 shown in FIG. 1. Accordingly, the corotational unit 23 in the exemplary embodiment shown in FIG. 1 and in the exemplary embodiment shown in FIG. 2 can be in the form of a one-piece double gearwheel and/or triple gearwheel. Moreover, the third transmission element 18 and the locking motor 13 can also be arranged in the exemplary embodiment shown in FIG. 1 as they are in the exemplary embodiment shown in FIG. 2.

In the following, the mode of operation of the control unit 29 for operating an actuating drive 1, in particular as shown in FIG. 1 and/or FIG. 2, is discussed. The actuating drive 1 can be designed according to the preceding description, and the aforementioned features can be present individually or in any combination.

In order to be able to carry out the at least one operating method described in the following, the actuating drive 1 includes the drive train 2. The drive train 2 includes the drive transmission 5. The drive transmission 5 is non-self-locking. Furthermore, the drive transmission 5 has the drive motor 3 for driving the drive transmission 5. Moreover, the actuating drive 1 includes the locking unit 12 for locking the drive train 2. This locking unit 12 includes the self-locking locking transmission 15 which is mechanically operatively connected to the drive transmission 5. Via this mechanical operative connection, the locking transmission 15 can lock the drive transmission 5 and the drive motor 3, when the drive motor 3 is not energized. In addition, the locking unit 12 includes the locking motor 13 for driving the locking transmission 15. The actuating drive 1 also has the control unit 29 for controlling the drive motor 3 and the locking motor 13. The control unit 29 is designed such that the drive motor 3 and the locking motor 13 can be operated, in particular in a starting operation, asynchronously and/or with a time delay relative to one another. The drive motor 3 and the locking motor 13 can be activated by the control unit 29 such that a blockage in the locking transmission 15 can be avoided and/or released. One advantage is that the locking motor 13 can therefore be very small and low-power, which in turn reduces the overall dimensions of the actuating drive 1 and lowers the manufacturing costs.

The control unit 29 is designed such that the drive motor 3 and the locking motor 13 can be operated by the control unit in a normal operating mode to actuate the assembly. During normal operation, the control unit 29 synchronously activates the drive motor 3 and the locking motor 13. As a result, the third transmission element 18 and the corotational unit 23 are moved synchronously in relation to each other. A first tooth flank 34 of the third transmission element 18 therefore precedes a first tooth flank 33 of the second transmission element 16. Moreover, in this case, a second tooth flank 36 of the third transmission element 18 follows a corresponding second tooth flank 35 of the second transmission element 16. The corresponding tooth flanks 33, 34, 35, 36 are therefore spaced apart from one another in the normal operating mode. Advantageously, frictional losses between the corotational unit 23 and the third transmission element 18 are therefore avoided, as a result of which the efficiency of the actuating drive 1 is improved.

Moreover, the control unit 29 is designed such that the drive motor 3 and the locking motor 13 can be operated, in particular during a restart of the actuating drive 1, after a period of inactivity and/or upon a reversal of the direction of rotation of the actuating drive 1, in at least one starting operation in order to avoid and/or release a blockage of the locking transmission 15. In this at least one starting operation, the drive motor 3 and the locking motor 13 are activated by the control unit 29 synchronously, asynchronously, simultaneously, and/or with a time delay in relation to each other.

FIGS. 3a, 3b, 3c show a schematic sectional view of the second transmission element 16 of the corotational unit 23 and of the third transmission element 18 of the locking transmission 15 of the actuating drive 1 at different points in time during a first starting operation. The actuating drive 1 can be designed according to the actuating drive 1 shown in FIG. 1 and/or FIG. 2, and the particular features can be present individually or in any combination.

In FIG. 3a, the first tooth flank 33 of the second transmission element 16 of the corotational unit 23 rests against the first tooth flank 34 of the third transmission element 18. In this case, a blockage can be formed between these two first tooth flanks 33, 34. It can also make sense to carry out the first starting operation, however, when the two tooth flanks 33, 34 are separated by a small distance.

In order to release and/or avoid this blockage, in the first starting operation, the locking motor 13 is activated and/or energized by the control unit 29 first, and only thereafter is the drive motor 3 activated and/or energized by the control unit. This is carried out, as shown in FIG. 3b, in a first direction of rotation 37 of the third transmission element 18, which is indicated by an arrow. As a result, the first tooth flank 34 of the third transmission element 18 is moved away from the first tooth flank 33 of the second transmission element 16. The technical effect is that, due to this activation, the blockage is released and/or avoided.

As shown in FIG. 3c, after a first time frame, the drive motor 3 is also activated and/or energized by the control unit 29. The first time frame is designed such that, and/or determined by the control unit 29 such that, the rotation of the second transmission element 16 begins before a second tooth flank 36 of the third transmission element 18 collides with a second tooth flank 35 of the second transmission element 16. The activation takes place such that the corotational unit 23, or the second transmission element 16, moves in a first direction of rotation 39 of the second transmission element 16, as indicated in FIG. 3c by another arrow. As a result, the first tooth flank 33 of the second transmission element 16 follows the first tooth flank 34 of the third transmission element 18. Since the third transmission element 18 is still moving in the first direction of rotation 37 thereof, the first starting operation now smoothly transitions into the normal operating mode, which was explained above.

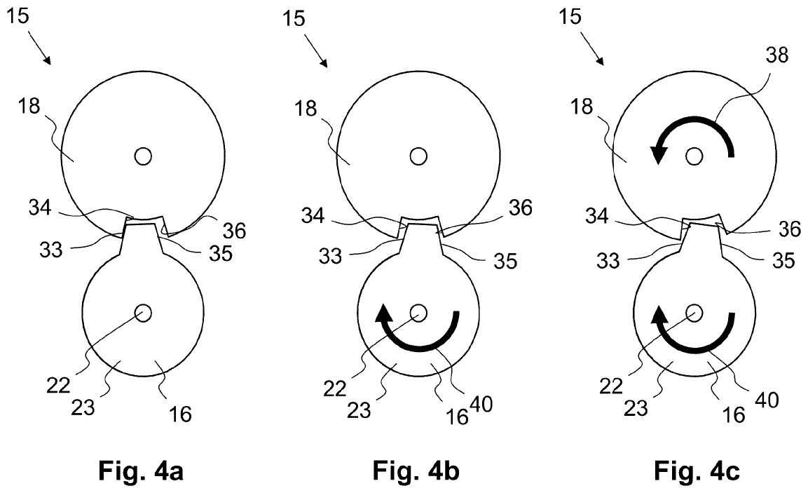

FIGS. 4a, 4b, 4c show a schematic sectional view of the second transmission element 16 of the corotational unit 23, and of the third transmission element 18 of the locking transmission 15 of the actuating drive 1 at different points in time during a second starting operation. In FIG. 4a, the first tooth flank 33 of the second transmission element 16 of the corotational unit 23 rests against the first tooth flank 34 of the third transmission element 18. In this case, a blockage can be formed between these two first tooth flanks 33, 34, as explained above. It can also make sense to carry out the second starting operation, however, when the two tooth flanks 33, 34 are separated by a small distance.

In order to release and/or avoid this blockage, in the second starting operation, the drive motor 3 is activated and/or energized by the control unit 29 first, and only thereafter is the locking motor 13 activated and/or energized by the control unit. This is carried out, as shown in FIG. 4b, in a second direction of rotation 40 of the second transmission element 16, which is indicated by an arrow. As a result, the first tooth flank 33 of the second transmission element 16 is moved away from the first tooth flank 34 of the third transmission element 18. The result is that, due to this activation, the blockage is released and/or avoided.

As shown in FIG. 4c, after a second time frame, the locking motor 13 is also activated and/or energized by the control unit 29. The first and the second time frames can be the same or different. The second time frame is designed such that, and/or determined by the control unit 29 such that, the rotation of the third transmission element 18 begins before the second tooth flank 35 of the second transmission element 16 collides with the second tooth flank 36 of the third transmission element 18. The activation takes place such that the third transmission element 18 moves in a second direction of rotation 38 of the third transmission element 18, as indicated in FIG. 4c by another arrow. As a result, the first tooth flank 34 of the third transmission element 18 follows the first tooth flank 33 of the second transmission element 16, which is moving away. Since the second transmission element 16 is still moving in the second direction of rotation 40 thereof, the second starting operation now smoothly transitions into the normal operating mode, which was explained above.

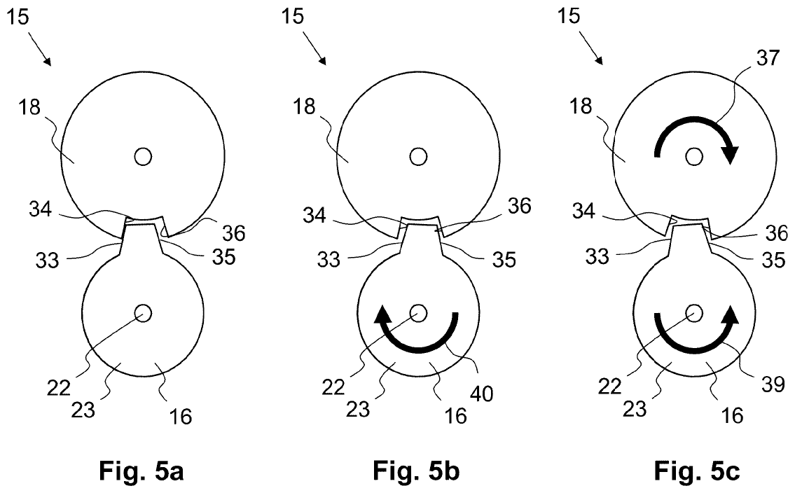

FIGS. 5a, 5b, 5c show a schematic sectional view of the second transmission element 16 of the corotational unit 23, and of the third transmission element 18 of the locking transmission 15 of the actuating drive 1 at different points in time during an alternative second starting operation. In FIG. 5a, the first tooth flank 33 of the second transmission element 16 of the corotational unit 23 rests against the first tooth flank 34 of the third transmission element 18. In this case, a blockage can be formed between these two first tooth flanks 33, 34, as explained above. It can also make sense to carry out the alternative second starting operation, however, when the two tooth flanks 33, 34 are separated by a small distance.

In order to release and/or avoid this blockage, in the alternative second starting operation shown in FIGS. 5a, 5b, 5c, as is also the case in the first variant of the second starting operation shown in FIGS. 4a, 4b, 4c, the drive motor 3 is activated first by the control unit 29. Only thereafter is the locking motor 13 activated and/or energized. This is carried out, as shown in FIG. 5b and also in FIG. 4b, in the second direction of rotation 40 of the second transmission element 16, which is indicated by the arrow. As a result, the first tooth flank 33 of the second transmission element 16 is moved away from the first tooth flank 34 of the third transmission element 18. Consequently, the blockage is released and/or avoided.

In contrast to the sequence of the second starting operation shown in FIGS. 4a, 4b, 4c, as shown in FIG. 5c, after a third time frame the drive motor 3 is activated and/or energized such that the direction of rotation of the second transmission element 16 and/or the direction of rotation of the corotational unit 23 is reversed. The third time frame corresponds to the second time frame or is shorter than the second time frame. Additionally or alternatively, the third time frame is selected such that the direction of rotation is reversed before the second tooth flank 35 of the second transmission element 16 impacts the second tooth flank 36 of the third transmission element 18.

As shown in FIG. 5c, the locking motor 13 is also activated and/or energized by the control unit 29 either simultaneously with or after the reversal of the direction of rotation of the second transmission element 16, specifically after the second time frame. The second and the third time frames can be the same or different, preferably the second time frame being longer than the third time frame. The second time frame is designed such that, and/or determined by the control unit 29 such that, the rotation of the third transmission element 18 begins before the first tooth flank 33 of the second transmission element 16 collides with the first tooth flank 34 of the third transmission element 18. The activation takes place such that the third transmission element 18 moves in the first direction of rotation 37 of the third transmission element 18, as indicated in FIG. 5c by another arrow. As a result, the first tooth flank 34 of the third transmission element 18 precedes the first tooth flank 33 of the second transmission element 16, which is moving towards same. Moreover, the second tooth flank 36 of the third transmission element 18 follows the second tooth flank 35 of the second transmission element 16. Since the second transmission element 16 is still moving in the first direction of rotation 39 thereof, the second starting operation, in this activation as well, now smoothly transitions into the normal operating mode, which was explained above.

The first starting operation as shown in FIGS. 3a, 3b, 3c, the second starting operation as shown in FIGS. 4a, 4b, 4c, and/or the second starting operation as shown in FIGS. 5a, 5b, 5c can also be similarly started beginning in the opposite direction of rotation when the second tooth flank 35 of the second transmission element 16 rests against the second tooth flank 36 of the third transmission element 18 or is arranged directly adjacent thereto, so that, between these, a blockage is present or is highly likely possible when the start takes place directly in the normal operating mode.

Moreover, it is advantageous when the first starting operation as shown in FIGS. 3a, 3b, 3c is carried out first and, only thereafter, if the first starting operation was not successful, the second starting operation as shown in FIGS. 4a, 4b, 5c and/or FIGS. 5a, 5b, 5c is carried out. Alternatively, this can also be carried out in the reverse order.

In order to avoid and/or release a blockage of the locking transmission 15, the first and/or the second starting operation(s) are/is carried out, preferably according to the preceding description, in particular during a restart after a period of inactivity and/or upon a reversal of the direction of rotation of the actuating drive 1. When the first starting operation is carried out first, then, thereafter, the second starting operation can also be carried out. It is also possible that the second starting operation is carried out first and, thereafter, the first starting operation is carried out. It is also advantageous when at least one of the starting operations is carried out only when a current limit value was exceeded immediately after the start, immediately after the reversal of the direction of rotation, and/or immediately prior to the last period of inactivity. The term “immediately” is understood in the preceding context to be a defined time frame which is, in particular, shorter than two seconds. Additionally or alternatively, it is advantageous when the at least one starting operation is carried out only when a blockage has been indirectly or directly detected via the sensor 32 and/or a determined likelihood of a blockage is very high. This can be the case, as explained above, when an actual position of the second transmission element 16 and/or of the third transmission element 18 is within the starting operation range stored in the control unit 29.

### LIST OF REFERENCE CHARACTERS

1 actuating drive
2 drive train
3 drive motor
4 first motor shaft
5 drive transmission
6 motor pinion
7 first transmission element
8 first toothing
9 output shaft
10 fourth transmission element
11 fifth transmission element
12 locking unit
13 locking motor
14 second motor shaft
15 locking transmission
16 second transmission element
17 worm gear
18 third transmission element
19 worm
20 second toothing
21 third toothing
22 common axis of rotation
23 corotational unit
24 first bearing range
25 second bearing range
26 first bearing element
27 second bearing element
28 housing
29 control unit
30 first electrical line
31 second electrical line
32 sensor
33 first tooth flank of the second transmission element
34 first tooth flank of the third transmission element
35 second tooth flank of the second transmission element
36 second tooth flank of the third transmission element
37 first direction of rotation of the third transmission element
38 second direction of rotation of the third transmission element
39 first direction of rotation of the second transmission element
40 second direction of rotation of the second transmission element

1-15. (canceled)

16. An actuating drive for an electrical assembly of a motor vehicle, the actuating drive comprising:
a drive train including a drive transmission and a drive motor configured to drive the drive transmission;
a locking unit configured to lock the drive train, the locking unit including a self-locking locking transmission that is operatively connected to the drive transmission, and a locking motor configured to drive the locking transmission; and
a control unit configured to control an operation of the drive motor and the locking motor such that the drive motor and the locking motor can be operated, in a starting operation, asynchronously and/or with a time delay relative to one another.

17. The actuating drive according to claim 16, wherein control unit is further configured to control the operation of the drive motor and the locking motor such that the drive motor and the locking motor can be operated, in a normal operation, synchronously and/or simultaneously.

18. The actuating drive according to claim 16, wherein:
a first transmission element, a second transmission element, and/or a fourth transmission element of the actuating drive are jointly in the form of a corotational unit; and/or
the corotational unit is mounted rotatably about a common axis of rotation of the actuating drive.

19. The actuating drive according to claim 16, wherein the locking motor is smaller and/or has lower electrical power than the drive motor.

20. The actuating drive according to claim 16, wherein the control unit is configured to control the operation of the drive motor and the locking motor such that the drive motor and the locking motor can be operated, during a restart after a period of inactivity and/or upon a reversal of a direction of rotation of the actuating drive, first in the starting operation and, thereafter, in the normal operating mode to actuate the actuating drive.

21. The actuating drive according to claim 16, wherein the control unit is configured such that, during the normal operation, the control unit operates the locking motor such that a first tooth flank of a third transmission element of the locking transmission precedes a corresponding first tooth flank of a second transmission element of the locking transmission and/or that a second tooth flank of the third transmission element follows a corresponding second tooth flank of the second transmission element.

22. The actuating drive according to claim 16, wherein the starting operation comprises a first starting operation, wherein the control unit is configured to, in the first starting operation in order to avoid and/or release a blockage of the locking transmission, energize the locking motor first and, after a first time frame, energize the drive motor, the first time frame being stored in the control unit or established by the control unit.

23. The actuating drive according to claim 22, wherein the locking motor is energized first in the first starting operation such that a third transmission element of the locking transmission is rotated in a direction of rotation which corresponds to a planned actuating motion of the actuating drive, so that a tooth flank of the third transmission element that is adjacent to or in contact with a corresponding tooth flank of a second transmission element of the locking transmission moves away from the corresponding tooth flank of the second transmission element.

24. The actuating drive according to claim 23, wherein the drive motor is energized in the first starting operation after the first time frame such that the second transmission element) is rotated in a direction of rotation that corresponds to the planned actuating motion of the actuating drive, so that the tooth flank of the second transmission element follows the corresponding tooth flank of the third transmission element.

25. The actuating drive according to claim 24, wherein the first time frame is established and/or determined such that rotation of the second transmission element begins before another tooth flank of the third transmission element, which is moving towards the corresponding tooth flank of the second transmission element, collides with the corresponding tooth flank of the second transmission element.

26. The actuating drive according to claim 16, wherein the starting operation comprises a second starting operation, wherein the control unit is configured to, in the second starting operation in order to avoid and/or release a blockage of the locking transmission, first energize the drive motor, and
after a second time frame stored in the control unit or established by the control unit, the control unit is configured to energize the locking motor and/or, simultaneously with or after the energization of the locking motor, reverse the direction of rotation of the drive motor.

27. The actuating drive according to claim 26, wherein the drive motor is energized first in the second starting operation such that a second transmission element of the locking transmission is rotated in a direction of rotation that corresponds to or is opposite a planned actuating motion of the actuating drive, so that a tooth flank of the second transmission element that is adjacent to or in contact with a corresponding tooth flank of a third transmission element of the locking transmission moves away from the corresponding tooth flank of the third transmission element.

28. The actuating drive according to claim 27, wherein the drive motor, in the second starting operation, when the second transmission element has been rotated in a direction of rotation opposite the planned actuating motion of the actuating drive, is subsequently energized such that the direction of rotation thereof reverses, so that the second transmission element rotates in the direction of rotation corresponding to the planned actuating motion of the actuating drive.

29. The actuating drive according to claim 27, wherein the locking motor is energized in the second starting operation after the second time frame such that the third transmission element is rotated in a direction of rotation that corresponds to the planned actuating motion of the actuating drive so that the tooth flank of the third transmission element follows the corresponding tooth flank of the second transmission element.

30. The actuating drive according to claim 27, wherein the second time frame is established and/or determined such that the rotation of the third transmission element begins before another tooth flank of the second transmission element, which is moving towards the corresponding tooth flank of the third transmission element, collides with the corresponding tooth flank of the third transmission element.
